(19) United States
(12) Patent Application Publication
(10) Pub. No.: US 2020/0339828 A1
(43) Pub. Date: Oct. 29, 2020

(54) PHOTOCURABLE COMPOSITION

(71) Applicant: CANON KABUSHIKI KAISHA, Tokyo (JP)

(72) Inventors: Fei Li, Austin, TX (US); Weijun Liu, Cedar Park, TX (US)

(21) Appl. No.: 16/396,342

(22) Filed: Apr. 26, 2019

(51) Int. Cl. C09D 11/101; C09D 11/107; C09D 11/30

(52) U.S. Cl. CPC C09D 11/101; C09D 11/30; C09D 11/107

(57) ABSTRACT

A photocurable composition can comprise a polymerizable material and a photoinitiator, wherein at least 90 wt % of the polymerizable material may comprise acrylate monomers including an aromatic group. The photocurable composition can have a viscosity of not greater than 15 mPa·s, the total carbon content of the photocurable composition after curing can be at least 73%, and the Ohnishi number may be not greater than 3.0.

### FIELD OF THE DISCLOSURE

The present disclosure relates to a photocurable composition, particularly to a photo-curable composition for inkjet adaptive planarization.

### BACKGROUND

Inkjet Adaptive Planarization (IAP) is a process which planarizes a surface of a substrate, e.g., a wafer containing an electric circuit, by jetting liquid drops of a photocurable composition on the surface of the substrate, and bringing a flat superstrate in direct contact with the added liquid to form a flat liquid layer. The flat liquid layer is typically solidified under UV light exposure, and after removal of the superstrate a planar surface is obtained which can be subjected to subsequent processing steps, for example baking, etching, and/or further deposition steps. There exists a need for improved IAP materials leading to planar photo cured layers with high etch resistance, high mechanical strength, and good thermal stability.

### SUMMARY

In one embodiment, a photo-curable composition can comprise a polymerizable material and a photoinitiator, wherein at least 90 wt % of the polymerizable material comprises acrylate monomers including an aromatic group; and a total carbon content of the photocurable composition after curing can be at least 70%.

In one aspect, at least 99 wt % of the polymerizable material can comprise monomers including an aromatic ring structure.

In another aspect, at least 10 wt % of the polymerizable material can be a bi-functional acrylate containing an aromatic group.

In a further aspect, the bi-functional acrylate monomer containing an aromatic group can be bisphenol A dimethacrylate (BPADMA).

In yet a further aspect, the polymerizable material can include at least three different types of acrylate monomers, wherein each of the at least three different types of acrylate monomers contains an aromatic group.

In another aspect, the polymerizable material can include at least two monomer types selected from benzyl acrylate (BA), benzyl methacrylate (BMA), 1-naphthyl methacrylate (1-NMA), bisphenol A dimethacrylate (BPADMA), divinylbenzene (DVB), or 1-naphthyl acrylate (1-NA). In a particular aspect, the photocurable composition can include at least BA and BPADMA. In another particular aspect, the photocurable composition can include at least BA and BPADMA and further 1-NA or 1-NMA.

In another particular aspect, the polymerizable material can include at least 3 wt % divinylbenzene.

In yet a further aspect, the photocurable composition of the present disclosure can have a viscosity of not greater than 15 mPa·s.

In one embodiment, a laminate can comprise a substrate and a photo-cured layer overlying the substrate, wherein the photo-cured layer comprises a total carbon content of at least 73% and an Ohnishi number of not greater than 3.0.

In one aspect, the photo-cured layer of the laminate can be made by UV curing a photocurable composition, wherein the photocurable composition comprises a polymerizable material and a photoinitiator, wherein at least 90 wt % of the polymerizable material comprises acrylate monomers including an aromatic group.

In another aspect, the photo-cured layer of the laminate can have a weight loss after heating at 250° C. for 60 seconds of not greater than 5.5%.

In a further aspect, the photo-cured layer of the laminate can have a hardness of at least 0.3 GPa.

In yet a further aspect, the photo-cure layer can have a Storage Modulus of at least 4.5 GPa.

In another embodiment, a method of forming a photo-cured layer on a substrate can comprise: applying a layer of a photocurable composition on the substrate; bringing the curable composition into contact with a superstrate; irradiating the photocurable composition with light to form a photo-cured layer; and removing the superstrate from the photo-cured product. The photocurable composition of the method can comprise a polymerizable material and a photoinitiator, wherein at least 90 wt % of the polymerizable material comprise acrylate monomers including an aromatic group. In one aspect, the total carbon content of the photo-cured layer can be at least 70%.

In another aspect, the photocurable composition used in the method of forming a photo-cured layer can have a viscosity of not greater than 15 mPa·s.

In a further aspect, the polymerizable material used in the method of forming a photo-cured layer can include at least two monomer types selected from benzyl acrylate (BA), benzyl methacrylate (BMA), 1-naphthyl methacrylate (1-NMA), bisphenol A dimethacrylate (BPADMA), divinylbenzene (DVB), or 1-naphthyl acrylate (1-NA).

In one aspect, the photo-cured layer obtained by the method can have an Ohnishi number of not greater than 3.0.

In yet another aspect, the photo-cured layer of the method can have a hardness of at least 0.3 GPa.

### BRIEF DESCRIPTION OF THE DRAWINGS

Embodiments are illustrated by way of example and are not limited in the accompanying figures.

FIG. 1 includes a graph illustrating the amount of material removed by oxygen etching from layers of cured samples according to embodiments and comparing it with the material removal during oxygen etching of a commercial resist sample for NIL.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the invention.

### DETAILED DESCRIPTION

The following description is provided to assist in understanding the teachings disclosed herein and will focus on specific implementations and embodiments of the teachings. This focus is provided to assist in describing the teachings and should not be interpreted as a limitation on the scope or applicability of the teachings.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the imprint and lithography arts.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to a photocurable composition comprising a polymerizable material which includes to a large extent acrylate monomers having an aromatic group. The photocurable composition can be particularly suitable for use in IAP for making planar cured layers having a surprisingly high etch stability, good mechanical strength and thermal stability.

In one embodiment, at least 90 wt % of the polymerizable material can include acrylic monomers containing an aromatic group in their chemical structure. In further aspects, the amount of acrylic monomers containing an aromatic group can be at least 92 wt %, or at least 94 wt %, or at least 96 wt %, or at least 98 wt %, or at least 99 wt %, or 100 wt % based on the total weight of the polymerizable material.

Some non-limiting examples of acrylic monomers comprising an aromatic group can be: benzyl acrylate (BA), benzyl methacrylate (BMA), 1-naphthyl methacrylate (1-NMA), bisphenol A dimethacrylate (BPADMA), 1-naphthyl acrylate (1-NA), 2-naphthyl acrylate (2-NA), 9,9-bis[4-(2-acryloyloxy ethoxy) phenyl]fluorine (A-BPEF), 9-fluorene methacrylate (9-FMA), 9-fluorene acrylate (9-FA), o-phenylbenzyl acrylate (o-PBA), bisphenol A diacrylate (BPADA), or propenoic acid, 1,1′-[1,1′-binaphthalene]-2,2′-diyl ester (BNDA).

In one embodiment, at least 10 wt % of the polymerizable material can include a bi-functional acrylate containing an aromatic group. In a certain particular aspect, the bi-functional acrylate containing an aromatic group can be bisphenol A dimethacrylate (BPADMA).

In another certain embodiment, mono-functional, bi-functional or tri-functional monomers can be contained in the polymerizable material which do not possess an acrylate group but also contain an aromatic group. Non-limiting examples for such monomers can be methacrylates, vinyl ethers, vinyl esters, and other olefin monomers which are substituted with an aromatic group. In a particular aspect, divinyl benzene can be part of the polymerizable material, which includes a benzene ring bonded to two vinyl groups as active functional groups. In one aspect, the amount of divinyl benzene in the polymerizable material can be at least 5 wt % based on the total amount of polymerizable material.

In another embodiment, the polymerizable material can include at least two different types of acrylate monomers including an aromatic group, such as at least three-, at least four-, or at least five different types of acrylate monomers including an aromatic group.

The polymerizable material can further include one or more monomers, oligomers, or polymers which do not contain an aromatic group and include mono- or multi-functional groups per monomer unit. In one embodiment, the amount of polymerizable compounds not including an aromatic group can be between 0.1 wt % to 10 wt % based on a total weight of polymerizable material, such as between 1 wt % and 8 wt %, or between 2 wt % and 5 wt % based on the total weight of the polymerizable material. Certain non-limiting examples of polymerizable compounds not including an aromatic group can be: 2-ethyl hexyl acrylate, butyl acrylate, ethyl acrylate, methyl acrylate, isobornyl acrylate, stearyl acrylate, or any combination thereof.

Important for the selection of monomers is the aspect of maintaining a low viscosity of the polymerizable composition before curing. In one embodiment, the viscosity of the curable composition can be not greater than 20 mPa·s, such as not greater than 15 mPa·s, not greater than 12 mPa·s, not greater than 10 mPa·s, not greater than 9 mPa·s, or not greater than 8 mPa·s. In other certain embodiments, the viscosity may be at least 2 mPa·s, such as at least 3 mPa·s, at least 4 mPa·s, or at least 5 mPa·s. In a particularly preferred aspect, the curable composition can have a viscosity of not greater than 15 mPa·s. As used herein, all viscosity values relate to viscosities measured at a temperature of 23° C. with the Brookfield method using a Brookfield Viscometer at 200 rpm.

The amount of polymerizable material in the photocurable composition can be at least 5 wt % based on the total weight of the composition, such as at least 10 wt %, at least 15 wt %, at least 20 wt %, at least 30 wt %, at least 50 wt %, at least 60 wt %, at least 70 wt %, at least 80 wt %, or at least 90 wt %, or at least 95 wt %. In another aspect, the amount of polymerizable material may be not greater than 98 wt %, such as not greater than 97 wt %, not greater than 95 wt %, not greater than 93 wt %, not greater than 90 wt %, or not greater than 85 wt %, based on the total weight of the photocurable composition. The amount of polymerizable material can be a value between any of the minimum and maximum values noted above. In a particular aspect, the amount of polymerizable compound can be at least 70 wt % and not greater than 98 wt %.

The photocurable composition can further contain one or more optional additives. Non-limiting examples of optional additives can be stabilizers, dispersants, solvents, surfactants, inhibitors or any combination thereof.

It has been surprisingly discovered that by selecting certain combinations of polymerizable monomers containing aromatic groups, photocurable compositions can be made having a desired low viscosity of less than 10 mPa·s, but leading to cured materials having a high etch resistance, a low shrinkage during UV curing, and an excellent mechanical stability and heat stability.

In one embodiment, the photocurable composition can be applied on a substrate to form a photo-cured layer. As used herein, the combination of substrate and photo-curable layer overlying the substrate, is called a laminate.

In one aspect, the photo-cured layer of the laminate can have an Ohnishi number of not greater than 3.0, such as not greater than 2.9, not greater than 2.8, not greater than 2.7, or not greater than 2.6. In another aspect, the Ohnishi number may be at least 1.8, such as at least 1.9, at least 2.0, at least 2.1, at least 2.2, or at least 2.3.

In another aspect, the photo-cured layer of the laminate can have a hardness of at least 0.3 GPa, such as at least 0.32 GPa, at least 0.34 GPa, at least 0.36 GPa, or at least 0.38 GPa.

In a further aspect, the storage modulus of the photo-cured layer can be at least 4.5 GPa, such as at least 4.6 GPa, at least 4.7 GPa, at least 4.8 GPa, at least 4.9 GPa, at least 5.0 GPa, or at least 5.1 GPa.

The photo-cured layer of the laminate can further have a good heat stability. In one aspect, the photo-cured layer can have a weight loss of not greater than 6%, such as not greater than 5.5%, not greater than 5.0%, not greater than 4%, not greater than 3%, or not greater than 2.5% if heated at a speed of 20° C./min to a temperature of 250° C. and being hold for 60 seconds at 250° C.

The selection of monomers including aromatic groups of the photocurable material can lead to a high carbon content in the photo-cured layer. In one embodiment, the carbon content of the photo-cured layer can be at least 70%, such as at least 72%, at least 73%, at least 74%, at least 75%, at least 76%, or at least 77%. In a particular aspect, the carbon content is at least 73%.

In a further aspect, the glass transition temperature of the photo-cured layer of the laminate can be at least 80° C., such as at least 85° C., at least 90° C., at least 100° C., at least 110° C., at least 120°, or at least 130° C.

In a particular embodiment, the photo-cured layer can have a carbon content of at least 70%, a glass transition temperature of at least 85° C., and an Ohnishi number of not greater than 3.0.

The present disclosure is further directed to a method of forming a photo-cured layer. The method can comprise applying a layer of the photocurable composition described above over a substrate, bringing the photocurable composition into contact with a template or superstrate; irradiating the photocurable composition with light to form a photo-cured layer; and removing the template or the superstrate from the photo-cured layer.

The substrate and the solidified layer may be subjected to additional processing, for example, an etching process, to transfer an image into the substrate that corresponds to the pattern in one or both of the solidified layer and/or patterned layers that are underneath the solidified layer. The substrate can be further subjected to known steps and processes for device (article) fabrication, including, for example, curing, oxidation, layer formation, deposition, doping, planarization, etching, formable material removal, dicing, bonding, and packaging, and the like.

The photo-cured layer may be further used as an interlayer insulating film of a semiconductor device, such as LSI, system LSI, DRAM, SDRAM, RDRAM, or D-RDRAM, or as a resist film used in a semiconductor manufacturing process.

As further demonstrated in the examples, it has been surprisingly discovered that a certain combinations of polymerizable monomers containing aromatic groups in a photocurable composition can have very suitable properties especially for IAP processing. The photocurable composition of the present disclosure can have a desired low viscosity of less than 15 mPa·s and can form photo-cured layers with high mechanical strength, high thermal stability and low shrinkage.

### EXAMPLES

The following non-limiting examples illustrate the concepts as described herein.

### Example 1

Preparing of Photocurable IAP Compositions.

Ten photocurable compositions (samples S1 to S10) were prepared by combining for each sample at least three different types of polymerizable monomers containing an aromatic group (see Table 1), a photoinitiator (2.88 wt % Irgacure 819 from LabNetworks), and two surfactants (0.96 wt % of a mixture of FS2000M1, from Daniel lab LLC, and Chemguard S554-100 from Chemguard). The following polymerizable monomers containing an aromatic group were used for making the photocurable compositions: benzyl acrylate (BA); 1-naphthyl methacrylate (1-NMA), 1-naphthyl acrylate (1-NA); bisphenol A dimethacrylate (BPADMA); and divinylbenzene (DVB), 9,9-bis[4-(2-acryloyloxy ethoxy) phenyl]fluorine (A-BPEF), 9-fluorene methacrylate (9-FMA), 9-fluorene acrylate (9-FA), o-phenylbenzyl acrylate (o-PBA), bisphenol A diacrylate (BPADA), or propenoic acid, 1,1′-[1,1′-binaphthalene]-2,2′-diyl ester (BNDA). The specific monomer-types and monomer amounts of samples S1 to S10 are summarized in Table 1.

TABLE 1

| Sample | S1 | S2 | S3 | S4 | S5 | S6 | S7 | S8 | S9 | S10 |
|---|---|---|---|---|---|---|---|---|---|---|
| DVB | 4.81 | | | | | | | | | |
| BA | 24.04 | 48.08 | 48.08 | 48.08 | 48.08 | 48.08 | 48.08 | 48.08 | 48.08 | 48.08 |
| BMA | 19.23 | | | | | | | | | |
| o-PBA | | | | | 28.85 | 28.85 | | | | |
| 1-NMA | 28.25 | | | | | | | | | |
| 1-NA | 28.85 | 28.85 | 28.85 | | | | | | 28.85 | 28.85 |
| 2-NA | | | | | | | 28.85 | | | |
| BPADMA | 19.23 | 19.23 | | 19.23 | 19.23 | | 19.23 | 19.23 | | |
| A-BPEF | | | 19.23 | | | | | | | |
| 9-FMA | | | | 28.85 | | | | | | |
| 9-FA | | | | | | | | 28.85 | | |
| BNDA | | | | | | | | | 19.23 | |
| BPADA | | | | | | 19.23 | | | | 19.23 |

The tested properties of samples S1 to S10, such as viscosity, UV shrinkage during curing, glass transition temperature Tg after curing, carbon number, and Ohnishi number are summarized in Table 2. The curing was conducted after applying a liquid film of the photocurable composition of about 100 nm thickness on a glass substrate, and subjecting the liquid film to a UV light intensity of 4 mW/cm² and curing it for 600 s seconds, which corresponds to a curing energy dosage of 2.4 J/cm².

Table 2 further includes for several samples data from thermal gravimetric analysis (TGA), by measuring the weight loss of the samples during heating at a speed of 20° C. per minute up to 250° C. and holding the temperature for 60 seconds at this temperature. This investigation was conducted in order to simulate the wafer baking processing. Not being bound to theory, the variation in the weight loss during heat treatment at 250° C. of the samples can indicate that in samples with a lower weight loss (e.g., samples S2, S3, and S9), a larger degree of monomers were polymerized than in samples of a higher weight loss (e.g., S1).

TABLE 2

| | | UV shrink- | | | | |
|---|---|---|---|---|---|---|
| | | age during | | Carbon | | Weight |
| | Viscosity | curing | | content | Ohnishi | loss at |
| Sample | [mPa · s] | [%] | Tg | [%] | No. | 250° C. |
| S1 | 7.8 | 5.1 | 139 | 77.05 | 2.58 | 5.2 |
| S2 | 8.34 | 5.1 | 90 | 75.82 | 2.59 | 2.4 |
| S3 | 14.23 | 4.1 | 78 | 76.04 | 2.55 | 2.16 |
| S4 | 9.72 | 5.4 | 116 | 76.67 | 2.57 | n.a. |
| S5 | 8.10 | 4.2 | 81.5 | 76.39 | 2.60 | 3.29 |
| S6 | 8.35 | 4.4 | 67.7 | 76.31 | 2.57 | 3.46 |
| S7 | 7.77 | 4.3 | 97.5 | 75.82 | 2.59 | n.a. |
| S8 | 10.0 | 5.9 | 104 | 76.59 | 2.55 | 3.31 |
| S9 | 10.5 | 4.4 | 83.1 | 76.49 | 2.49 | 2.32 |
| S10 | 8.29 | 5.5 | 80 | 75.75 | 2.56 | n.a. |

The viscosity of the samples was measured at 23° C., using a Brookfield Viscometer LVDV-II+Pro at 200 rpm, with a spindle size #18. For the viscosity testing, about 6-7 mL of sample liquid was added into the sample chamber, enough to cover the spindle head. For all viscosity testing, at least three measurements were conducted and an average value was calculated.

The shrinkage measurements were performed with an Anton Paar MCR-301 rheometer coupled to an UV curing system and heater. For the testing, a 7 μl drop of the test sample was added onto a plate and a temperature control hood was released to insulate the drop and the measuring unit. The amount of the sample was designed to obtain a thickness (hereinafter also called height) of the sample layer of slightly higher than 0.1 mm. By pre-setting the target height to 0.1 mm, the measuring unit moved down to the set value, causing extra amount of resist flowing off the plate. This insured that the exact height of the liquid resist was 0.1 mm before curing. Thereafter, the resist was cured with a UV power of 4 mW/cm² at 365 nm for 600 seconds. After curing of the resist, the height was measured again and the linear shrinkage calculated according to equation (1).

### Example 2

Mechanical Properties of the Photocured Samples S1 and S2 Described in Example 1 were Tested by Nanoindentation Using a Hysitron TI 950 Triboindenter.

A summary of the tested average contact depth, average storage modulus, and average hardness is shown in Table 3.

As comparison, a comparative sample C1 was tested, which is a typical resist material for nanoimprint lithography (NIL). The comparative sample C1 contained the following ingredients: isobornyl acrylate (IBOA) in an amount of 33.3 wt %, dicyclopentenyl acrylate (DCPA) in an amount of 19.4 wt %, benzyl acrylate (BA) in an amount of 22.2 wt %, neopentyl glycol diacrylate (A-NPG) in an amount of 18.5 wt %, photoinitiator Irgacure 907 in an amount of 0.925 wt %, Irgacure 651 in an amount of 1.85 wt %, and surfactants in an amount of 3.79 wt %. Comparative sample C1 had a viscosity of 7 mPa s, a UV shrinkage during curing of 4.2%, a carbon content of 71%, a glass transition temperature of 90° C., and an Ohnishi number of 3.27.

The results show that both samples, S1 and S2, had a higher hardness and higher storage modulus than comparative sample C1.

TABLE 3

| | Avg. Contact | Avg. Storage | Avg. Hardness |
|---|---|---|---|
| Sample | Depth [nm] | Modulus [GPa] | [GPa] |
| S1 | 194.0 ± 1.0 | 4.92 ± 0.16 | 0.399 ± 0.015 |
| S2 | 194.9 ± 2.1 | 5.23 ± 0.41 | 0.429 ± 0.017 |
| C1 | 198.7 ± 0.8 | 4.15 ± 0.18 | 0.260 ± 0.021 |

The storage modulus and glass transition temperature were measured with an Anton-Paar MCR-301 rheometer coupled with a Hamamatsu Lightningcure LC8 UV source. The sample was radiated with a UV intensity of 1.0 mW/cm² at 365 nm controlled by a Hamamatsu 365 nm UV power meter. Software named RheoPlus was used to control the rheometer and to conduct the data analysis. The temperature was controlled by a Julabo F25-ME water unit and set to 23° C. as starting temperature. For each sample testing, 7 μl resist sample was added onto a glass plate positioned directly underneath the measuring system of the rheometer. Before starting with the UV radiation, the distance between glass plate and measuring unit was reduced to a gap of 0.1 mm. The UV radiation exposure was continued until the storage modulus reached a plateau, and the height of the plateau was recorded as the storage modulus listed in Table 3.

After the UV curing was completed, the temperature of the cured sample was increased by controlled heating to measure the change of the storage modulus in dependency to the temperature to obtain the glass transition temperature T_{g}. As glass transition temperature T_{g} was considered the temperature corresponding to the maximal value of Tangent (θ).

The hardness was calculated from loading curves measured with the Hysitron TI 950 Triboindenter by indent to 200 nm, using the displacement controlled loading function. During indentation, the force was measured, from which the loading curves could be obtained. The hardness (H) was calculated according to the following equation: H=Pₘₐₓ/A_{c}, wherein Pₘₐₓ is the maximum applied force, and A_{c} is the contact area determined by the tip area function.

### Example 3

Investigation of Etch Resistance

For the study of the etch resistance, an about 100 nm thick liquid film per sample was printed on a blank template of an Imprio 1300 tool. The printed liquid film was photocured and thereafter subjected to oxygen etching. The etch processing was conducted using a Trion Oracle Etch system with the following plasma chemistry: O₂ Argon plasma using RIE excitation at 10 mtorr. The total processing time for each sample was about 60 seconds.

After the etching treatment, the amount of material removed during etching in the thickness direction of the 100 nm film was measured.

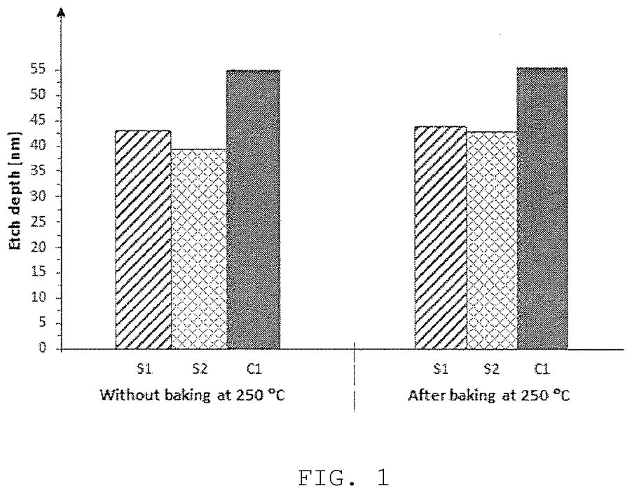

A summary of the etching test results is shown in Table 4 and FIG. 1. It can be seen that sample 51 was more resistant against oxygen etching than comparative sample C1. Specifically, sample 51 reached an etch depth (material removal in the thickness direction of the film) of about 43 nm, while comparative sample C1 was less resistant against the etching exposure and lost about 55 nm in depth. Accordingly, sample S1 was 21.4% more etch resistant than comparative sample C1.

A very similar etching behavior could be observed after subjecting the cured 100 nm thick layers to a baking treatment at 250° C. for 90 seconds, but before the etching. While sample S1 lost about 41 nm material in the thickness direction of the film during oxygen etching, comparative sample C1 had a material removal of about 53 nm.

The results of the etching experiments correspond to the calculated Ohnishi numbers of the tested samples. The samples with a high etch resistance had an Ohnishi number below 3, particularly, not greater than 2.6 (see S1 and S3), and the comparative sample C1 with a lower etch resistance had an Ohnishi number greater than 3 (see C1).

The Ohnishi number (ON) is known to be an empirical parameter and calculated as the ratio of total number of atoms (Nₜ) in the polymer repeat unit divided by the difference between the number of carbon atoms (N_{C}) and oxygen atoms (N_{O}) in the unit, ON=Nₜ/(N_{C}−N_{O}). For the calculation of the Ohnishi number, it was assumed that the cured materials contained 100 wt % of the polymerized monomer units formed by addition polymerization (no loss of atoms during polymerizations).

TABLE 4

| | Amount of material removed by oxygen | | |
|---|---|---|---|
| | etching in thickness direction [nm] | | |
| | without baking | after baking | |
| Sample | at 250° C. | at 250° C. | Ohnishi number |
| S1 | 43 | 41 | 2.58 |
| S2 | 39.4 | 40 | 2.59 |
| C1 | 55 | 52 | 3.27 |

### Example 4

Comparison of Different Curing Intensities with Regard to Thickness Change after Baking and UV Shrinkage.

Similar as in Example 1, a 100 nm thick film of sample S2 was formed and cured under different UV intensities (see Table 4), until a total dosage curing energy of 2.4 J/cm² was reached. After the curing, the cured samples were subjected to heat treatment at 250° C. for 90 seconds (baking), and the thickness change of the sample layers was measured. As can be seen in Table 4, the lowest UV curing intensity (4 mW/cm²) caused the lowest change of layer thickness during the baking treatment (6.5%). Increasing the UV intensity to 15 mW/cm², caused an additional increase of about 1.5% thickness reduction (7.98%).

TABLE 5

| | | Avg. |
|---|---|---|
| UV Intensity | Thickness reduction | thickness reduction |
| [mW/cm²] | [%] | [%] |
| 15 | 8.00 | 7.98 |
| | 7.95 | |
| 8.8 | 6.78 | 6.79 |
| | 6.80 | |
| 4 | 6.63 | 6.55 |
| | 6.47 | |

It was further investigated if the applied light intensity during curing of sample S2 has an influence concerning the shrinkage of the photocurable composition after UV curing. As can be seen in Table 5, changing the light intensity from 4 mW/cm² up to 100 mW/cm² had only a very minor influence on the shrinkage results. The shrinkage differences in view of different applied light intensities were less than 1%.

TABLE 6

| UV intensity | | | | Avg. Shrinkage |
|---|---|---|---|---|
| [mW/cm²] | Shrinkage after UV curing [%] | | | [%] |
| 4 | 3.90 | 4.90 | 5.10 | 4.63 |
| 20 | 4.50 | 4.70 | 4.80 | 4.67 |
| 50 | 4.20 | 4.80 | 4.40 | 4.47 |
| 100 | 3.70 | 4.20 | 3.80 | 3.90 |

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A photocurable composition, comprising a polymerizable material and a photoinitiator, wherein
at least 90 wt % of the polymerizable material comprise acrylate monomers including an aromatic group; and
a total carbon content of the photocurable composition after curing is at least 70%.

2. The photocurable composition of claim 1, wherein at least 99 wt % of the polymerizable material comprise monomer compounds including an aromatic ring structure.

3. The photocurable composition of claim 1, wherein at least 10 wt % of the polymerizable material is a bi-functional acrylate containing an aromatic group.

4. The photocurable composition of claim 3, wherein the bi-functional acrylate monomer containing an aromatic group is bisphenol A dimethacrylate (BPADMA).

5. The photocurable composition of claim 1, wherein the polymerizable material includes at least three different types of acrylate monomers including an aromatic group.

6. The photocurable composition of claim 1, wherein the polymerizable material includes at least 3 wt % divinylbenzene.

7. The photocurable composition of claim 1, wherein the polymerizable material includes at least two monomer types selected from benzyl acrylate (BA), benzyl methacrylate (BMA), 1-naphthyl methacrylate (1-NMA), bisphenol A dimethacrylate (BPADMA), divinylbenzene (DVB), or 1-naphthyl acrylate (1-NA).

8. The photocurable composition of claim 7, wherein the polymerizable material includes at least BA and BPADMA.

9. The photocurable composition of claim 8, wherein the polymerizable material further includes 1-NA or 1-NMA.

10. The photocurable composition of claim 1, wherein a viscosity of the photocurable composition is not greater than 15 mPa·s.

11. A laminate comprising a substrate and a photo-cured layer overlying the substrate, wherein the photo-cured layer comprises a total carbon content of at least 73% and an Ohnishi number of not greater than 3.0.

12. The laminate of claim 11, wherein the photo-cured layer is made by UV curing a photocurable compositing, the photocurable composition comprising a polymerizable material and a photoinitiator, wherein at least 90 wt % of the polymerizable material comprises acrylate monomers including an aromatic group.

13. The laminate of claim 11, wherein the photo-cured layer has a weight loss after heating at 250° C. for 60 seconds of not greater than 5.5%.

14. The laminate of claim 11, wherein the photo-cured layer has a hardness of at least 0.3 GPa.

15. The laminate of claim 11, wherein the photo-cured layer has a Storage Modulus of at least 4.5 GPa.

16. A method of forming a photo-cured layer on a substrate, comprising:
applying a layer of a photocurable composition on the substrate, wherein the photocurable composition comprises a polymerizable material and a photoinitiator, wherein at least 90 wt % of the polymerizable material comprise acrylate monomers including an aromatic group;
bringing the photocurable composition into contact with a superstrate;
irradiating the photocurable composition with light to form a photo-cured layer; and
removing the superstrate from the photo-cured product,
wherein a total carbon content of the photo-cured layer is at least 70%.

17. The method of claim 16, wherein the photocurable composition has a viscosity of not greater than 15 mPa·s.

18. The method of claim 16, wherein the polymerizable material includes at least two monomer types selected from benzyl acrylate (BA), benzyl methacrylate (BMA), 1-naphthyl methacrylate (1-NMA), bisphenol A dimethacrylate (BPADMA), divinylbenzene (DVB), or 1-naphthyl acrylate (1-NA).

19. The method of claim 16, wherein the photo-cured layer has an Ohnishi number of not greater than 3.0.

20. The method of claim 16, wherein the photo-cured layer has a hardness of at least 0.3 GPa.

21. The photocurable composition of claim 1, wherein a photo-cured layer of the photocurable composition has an Ohnishi number of not greater than 2.6.

22. The photocurable composition of claim 1, wherein a photo-cured layer of the photocurable composition has a weight loss after heating at 250° C. for 60 seconds of not greater than 5.5%, the photo-cured layer being made by applying a liquid film of the photo-curable composition of 100 nm thickness on a glass substrate and subjecting the liquid film to a UV light intensity of 4 mW/cm² for 600 seconds.

23. The photocurable composition of claim 1, wherein a photo-cured layer of the photocurable composition has a hardness of at least 0.3 GPa, the photo-cured layer being made by applying a liquid film of the photo-curable composition of 100 nm thickness on a glass substrate and subjecting the liquid film to a UV light intensity of 4 mW/cm² for 600 seconds.

24. The photocurable composition of claim 1, wherein a photo-cured layer of the photocurable composition has a Storage Modulus of at least 4.5 GPa, the photo-cured layer being made by applying a liquid film of the photo-curable composition of 100 nm thickness on a glass substrate and subjecting the liquid film to a UV light intensity of 4 mW/cm² for 600 seconds.
